(19) United States
(12) Patent Application Publication
(10) Pub. No.: US 2006/0244731 A1
(43) Pub. Date: Nov. 2, 2006

(54) Dynamic display system with interchangeable removable digital screens with posters in a backlighted housing

(76) Inventor: Jean-Jacques Mulleris, Neuilly sur Seine (FR)

Correspondence Address: NIXON & VANDERHYE, PC, 901 NORTH GLEBE ROAD, 11TH FLOOR, ARLINGTON, VA, 22203, US

(21) Appl. No.: 10/563,739

(22) PCT Filed: Jul. 9, 2004
(86) PCT No.: PCT/FR04/01817

§ 371 Date: May 8, 2006

(30) Foreign Application Priority Data
Jul. 10, 2003 (FR) 03/08502

(51) Int. Cl. G09G 5/00

(52) U.S. Cl. 345/173; 345/179

(57) ABSTRACT

The invention concerns a dynamic display system based on a backlighted box (1, 1′, 1″) provided with at least one front opening (10), support means (16) for supporting a poster frame (3), with a backlighting system for the poster. A removable digitally controlled display device (2) in inserted in the opening (10) left free by the poster. The removable device (2) comprises a front part formed by a flat display screen (200) mounted in a frame (20), and a controlling and managing rear part fixed on the back of the front part. The removable device (2) comprises an electrical and mechanical interface to set up a connection with an electric power supply and maintain the device in the opening (10).

The present invention relates to the field of displaying visual information. The invention more particularly relates to a display system allowing dynamic presentation of images via removable digital screens which may be plugged in a back-lighted case, and interchangeable with posters.

Presentation of visual information with posters positioned in back lighted boxes or cases currently called menu boards has become very widespread, notably in cafes and in large food service chains (snack bars, cafeterias, and fast-food). Thus, display systems exist with lighting positioned at the rear of the case (back-lighting), integrating one or more poster media, and possibly a price display area. Such systems therefore provide static presentation of visual information for customers. Static display systems have the drawback of requiring frequent renewal of the posters. As soon as the displayed information needs to be changed entirely or partially, it is necessary to remove at least one poster in order to replace it with a new one. This involves a downtime of the system and sometimes delicate handling for cases placed in height generally.

Display panels with a plasma screen occupying significant space are known from the prior art. Indeed, the case which contains these screens should also include the video power supply of the screen. Moreover, these screens have the drawback of giving off heat, which subjects them to heating. Therefore, they cannot be housed in confined spaces such as furniture or display cases with reduced space, and subjected to heat and to electromagnetic radiation from the lighting tubes.

A flat screen video display terminal installed in a trim case is known from Patent FR 2,810,784 of the same applicant. However, this system is not provided for withstanding heat sources and lighting tubes in a confined medium. The trim case does not allow presentation of images by lighted posters when the terminal is out of order or not powered. If the terminal is removed from the case, no replacement back-lighted display is allowed.

The object of the present invention is therefore to overcome one or several of the drawbacks of the prior art by defining a display system combining in a reduced volume back-lighted case, a poster-support device for presenting one or more posters, and a removable screen for presenting moving images.

For this purpose, the invention relates to a dynamic display system comprising a case provided with at least one frontal opening and at least one support means in the case for supporting at least one removable poster frame, a distributed lighting system in the case so as to provide back-lighting of the posters, characterized in that at least one removable digitally controlled display device is provided in exchange for at least one poster frame for covering said frontal opening(s), the removable device including a so-called front part, formed by a frame and a flat viewing screen mounted in the frame, and a controlling and managing rear part fixed to the back of the front part, an electrical and mechanical interface being provided on the removable device in order to establish, in a detachable manner, both a connection to an electrical power supply located in the case and securing of the device in a front location of the case.

Advantageously, with the invention, it is thereby possible to combine a static back-lighted display with a dynamic display.

According to another feature, the viewing screen is mounted in a frame with a shape and dimensions corresponding to an associated poster frame, securing means permanently fixed to the frame being provided to maintain the viewing screen in the front position.

According to another feature, the removable device is dimensioned so as to be interchangeable with a poster frame shown through said frontal opening, the means for supporting the poster frame being configured so as to be bound to fast securing means of the removable device.

According to another feature, the lighting system comprises at least one fluorescent tube, the rear part of the removable digitally controlled display device including a cover for protection against optical and electromagnetic radiations.

According to another feature of the invention, the rear part of the removable device has a format with dimensions less than or equal to the format of the frame of the front part, the rear part including handling and control electronic components fixed by attachment means and distributed on the back of the viewing screen forming the front part, the whole of the electronic components being positioned in a flattened space with a suitable shape, delimited by a protective cover, the thickness of which is between 2 and 10 cm.

According to another feature of the invention, the rear part of the screen notably comprises:
a module for video control of the flat screen,
graphics card means with or without a sound card,
a processing unit for the execution of software modules and notably the management of multimedia functions on the flat screen,
storage means for storing data representative of images and audio-video/digital animations.

According to another feature of the invention, the removable device includes means for communication and connection to a network in order to transmit and receive notably data of the digital audio-video type via at least one two-way channel.

According to another feature of the invention, the removable digitally controlled display device includes means for removing air heated by the management and control electronic components and display components.

According to another feature, the rear part comprises at least one localized cooling system for removing heat given off by at least one of the management and control electronic components.

According to another feature, the removable display device includes a ventilation intake provided with a filtering system for retaining oil vapours, fats, and other particles (smoke, etc.).

According to another feature, the front location of the case has a determined volume in order to contain the rear part of the removable device, the protective cover including a metal material with reflecting properties, the case comprising an opening frame with a removable or hinged window so that it may be folded back against the front opening.

According to another feature, the removable device comprises a reader for digital data media disks.

According to another feature, the reader is configured so as to be directly accessible through an access door located on the outside of the front location.

According to another feature, the screen of the removable device has determined dimensions, substantially equal to the dimensions of the frontal opening, matching means being provided in the video control module of the screen in order to match digital data representative of video and/or animations to the format of the viewing screen.

According to another feature of the invention, the means for supporting the poster frame consist in retaining profiles positioned on the rim of the frontal opening and capable of being secured onto the complementary profile located at the periphery of the poster frames and of the removable device, respectively.

According to another feature, the removable digitally controlled display device comprises user interface means connected through a physical and/or remote connection to the processing unit so as to provide control of the display on the screen, by using programming software stored in the storage means.

According to another feature, the removable digitally controlled display device is remotely controlled by a programming server connected to the network and having sources of information to be remotely transmitted, these sources of information notably including digital data, said programming server controlling a remote piece of equipment for maintenance of said device.

According to another feature, the case is substantially trapezium-shaped, the case comprising a horizontal bottom and top, the back of the case being substantially vertical, the frontal opening for the removable digitally controlled display device being inclined at an angle of between 0 and 30°, the maximum thickness of the case remaining less than 30 cm, and having a minimum thickness of the order of 10 cm, the lighting system comprising lighting means distributed over the height of the case.

According to another feature, partitions for channelling the air flow are provided in the rear part in order to delimit at least one limited area of forced ventilation around electronic components.

Another object of the present invention is to propose a digitally controlled display device which may be removably inserted in a box or case for presenting posters.

For this purpose, the invention relates to a removable digitally controlled display device intended to replace at least one poster frame in a box or case of the back-lighting display type and provided with at least one supporting means for supporting at least one removable poster frame and at least one frontal opening with a front location with determined dimensions, the device being characterized in that it includes an electrical and mechanical interface in order to establish, in a detachable manner, both a connection to an electrical power supply located in the case and securing of the device in the front location, a front part, formed by a frame and a flat viewing screen mounted in the frame, and a control and management rear part attached to the back of the front part.

According to another feature, the rear part of the removable digitally controlled display device includes a cover for protection against optical and electromagnetic radiations.

According to another feature, the rear part of the removable device has a format with dimensions less than or equal to the format of the frame of the front part, the rear part including management and control electronic components secured by attachment means and distributed over the back of the viewing screen forming the front part, the whole of the electronic components being positioned in a flattened space with a suitable shape, delimited by a protective cover, the thickness of which is between 2 and 10 cm.

According to another feature, the rear part of the screen notably comprises:
a module for video control of the flat screen,
graphics card means with or without a sound card,
a processing unit for the execution of software modules and notably the management of multimedia functions on the flat screen,
storage means for storing data representative of audio-video/digital images and animations.

According to another feature, the device according to invention includes means for removing the air heated by the management and control electronic components and display components.

According to another feature, the device according to the invention is of the type without any ventilation opening and including a radial ventilation assembly provided for stirring the air heated by the management and control electronic components and ensuring transmission of heat through the protective cover, said cover being based on a metal suitable for transmitting heat by convection and by radiation.

According to another feature, said rear part is provided with at least a fan tangentially positioned so as to produce an upward flow of air, at least one ventilation intake being provided on the front of the device below the viewing screen and a discharge outlet on the rear of the device.

The invention, with its features and advantages, will become more apparent upon reading the description made with reference to the appended drawings given as non-limiting examples wherein:

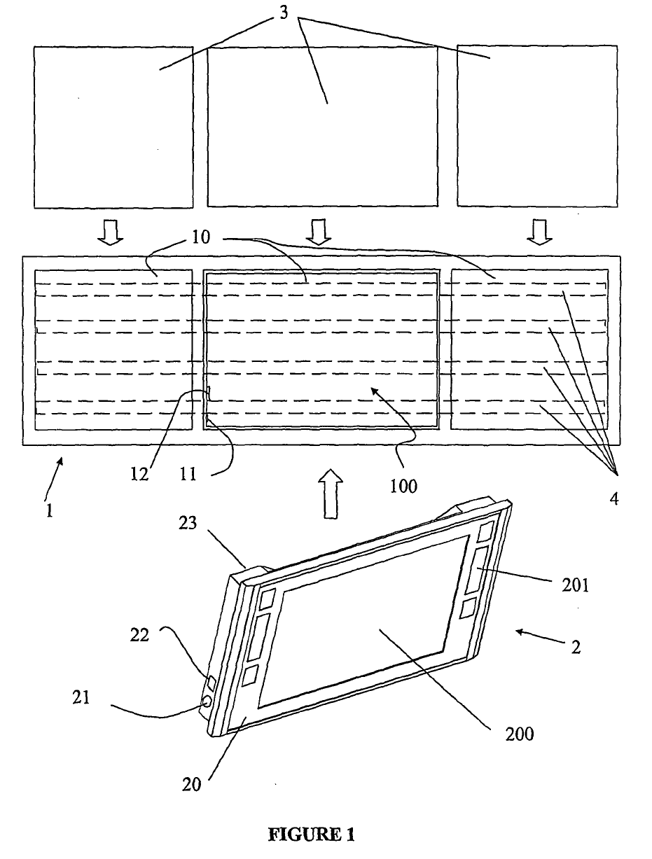

FIG. 1 illustrates an embodiment of the display system according to the invention,

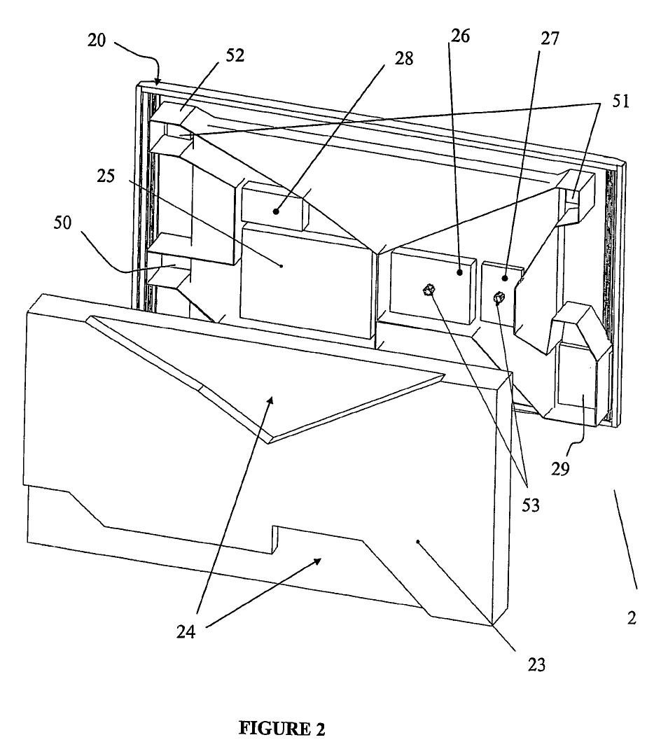

FIG. 2 illustrates a perspective view of an exemplary configuration of the rear part of the removable digitally controlled display device,

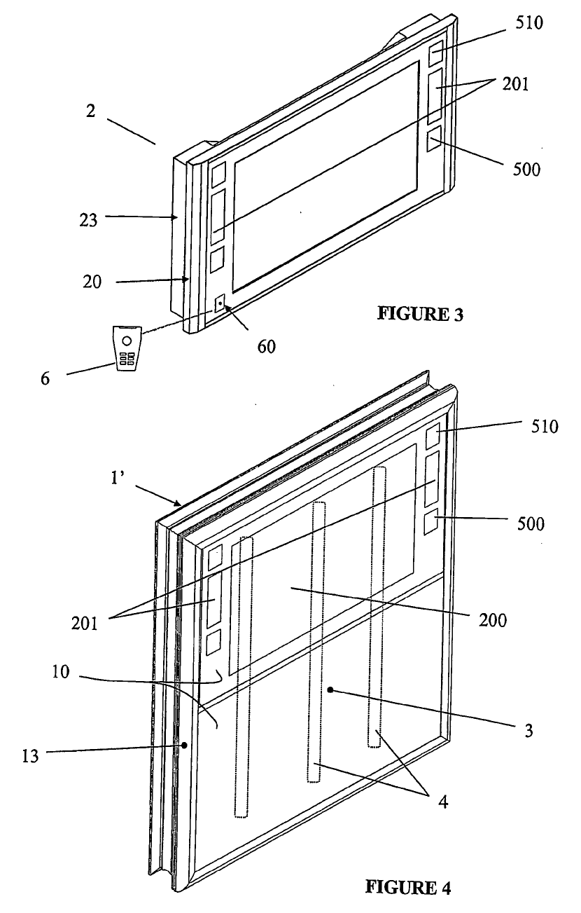

FIG. 3 illustrates a perspective view of the front part of the removable digitally controlled display device,

FIG. 4 illustrates a perspective view of an embodiment of the invention with two frontal openings, in which a presentation of a fixed image on a poster and of animated images is combined on a flat screen,

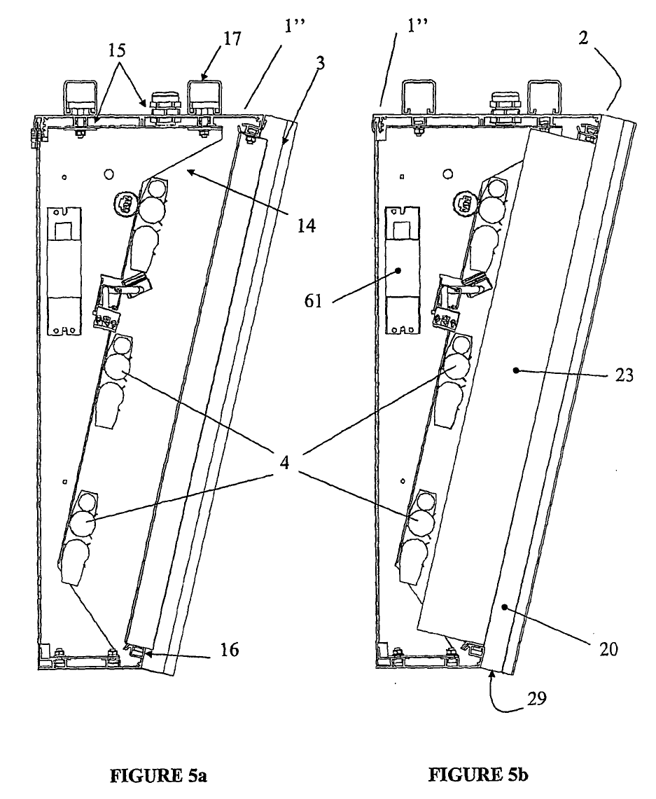

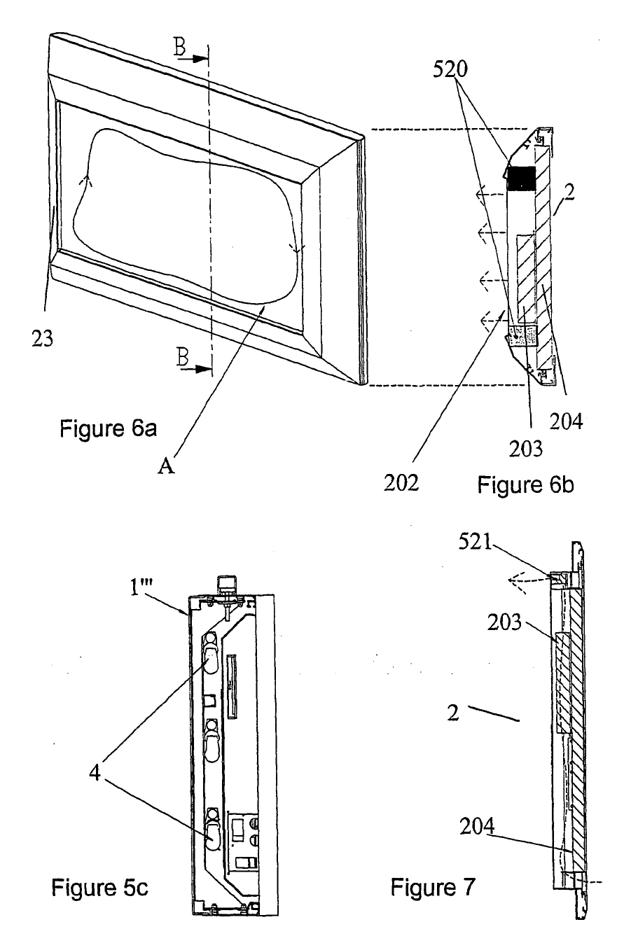

FIG. 5a shows a sectional view of a case with poster and FIG. 5b shows a sectional view of the same case with the dynamic display device replacing the poster frame,

FIG. 5c shows a sectional view along the B-B axis of FIG. 6a on a display device according to the invention in which the viewing screen is positioned parallel to the bottom of the box,

FIGS. 6a and 6b respectively illustrate a perspective view and a sectional view along the B-B axis of FIG. 6a, of a removable display device in a particular alternative of the invention,

FIG. 7 illustrates a top sectional view of a removable display device,

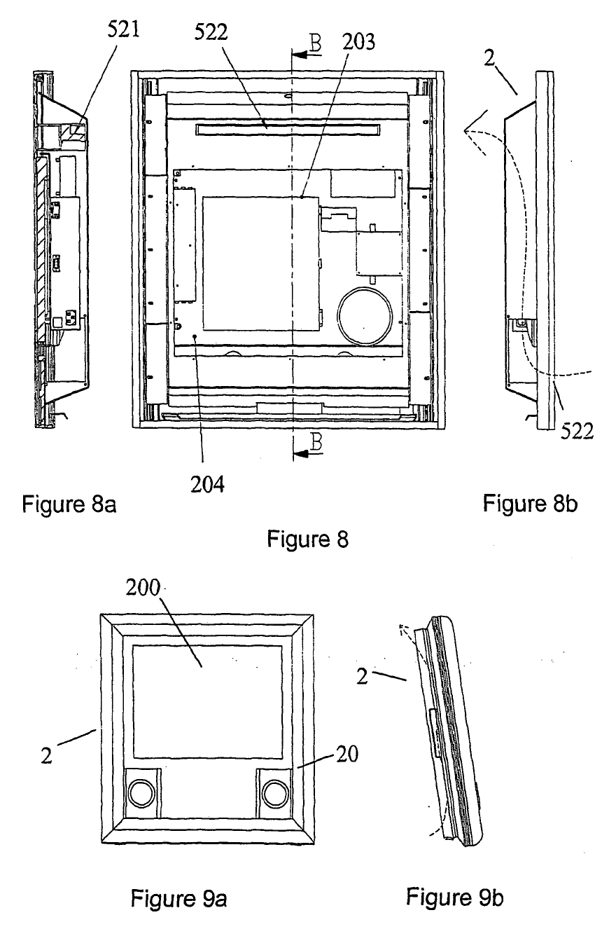

FIG. 8 shows a rear view of a removable display device,

FIGS. 8a and 8b illustrate side views of a removable display device according to the invention,

FIGS. 9a and 9b show a front view and a profile view of an embodiment of the removable display device according to the invention, respectively.

The invention will now be described with reference to FIGS. 1 and 2.

The dynamic display system comprises a case (1) provided with one or more frontal openings (10) to allow presentation of visual information by posters (3). These posters (3) are generally supported by rigid frames. According to the invention at least one frontal opening (10) includes a front location (100) with determined dimensions, for example formed by an accessible housing in the absence of a poster frame (3) and configured so as to receive a removable digitally controlled display device (2). As illustrated in FIG. 1, the removable device (2) includes a front part formed with a frame (20) in which a flat viewing screen (200) is mounted. The rear part of the removable digitally controlled display device (2) is attached to the back of the screen and possibly of the frame. The screen for example is an LCD (Liquid Crystal Display) screen with high light intensity, for example 500 candelas, or any other flat screen. This screen may be fitted with TFT (Thin Film Transistor) type technology. In an embodiment of the invention, the size of the frontal opening (10) giving access to the location or housing (100) corresponds to the format of the screen which for example and in a non-limiting way, may be of 20 or 40 inches (50 to 100 cm). The screens may be more or less elongated and diagonally reach dimensions less than 20 inches (50 cm) or larger than 40 inches (100 cm) in alternative embodiments.

In the example of FIG. 1, the case (1) comprises three openings (10) with dimensions which may vary. Supporting means are provided in the case (1) in order to support and hold a removable poster frame (3), for example along a plane parallel to the frontal opening. In an embodiment of the invention, the support means are notably distributed over the horizontal edges of the frontal openings (10) and may consist in profiles (16) having at least one groove for holding the poster frame (3). The case (1) illustrated in FIG. 1, thus allows the presentation of three aligned posters (3) side by side. These posters (3) are lighted by a lighting system (4) comprising fluorescent tubes. Fluorescent tubes are also positioned horizontally or vertically at the rear of the case (1). The tubes of the lighting system (4) are distributed over the height of the case (1) in order to provide substantially homogeneous lighting of the posters (3).

The display device according to the invention advantageously includes at least one removable digitally controlled display device (2) positioned in the front location (100) of the case. In the embodiment of FIG. 1, the display system integrates a digital video screen (200) in the centre, whereas both of the other openings allow presentation of static posters (3) lit up by the lighting system (4) with fluorescent tubes. Any of both of the other openings may also comprise a location for receiving a digital screen device with a corresponding format. More generally, any combination of posters (3) with one or more screens may be contemplated. A feature of the display system according to the invention is to allow integration of a dynamic display beside static images. This enhances the value and gives an attractive aspect to the displayed information.

The viewing screen (200) is mounted in a frame (20) with shape and dimensions corresponding to an associated poster frame (3), attachment means (not shown) firmly attached to the frame (20) are provided for holding the viewing screen (200) in the front position. It is understood that the system according to the invention may include frames with similar design for representing static posters and/or dynamic images, so that integration of the removable device (2) in a case with posters (3) is perfect. In other words, the visual difference between a removable device (2) with a screen (200) and a poster frame (3) is only noticeable by the animation of images in the case of the removable device (2).

In the particular case illustrated in FIG. 1, a third so-called replacement poster may be mounted in the central opening when the digitally controlled display device (2) is removed. The display system (4) may consist of fluorescent tubes positioned in the case (1) at the rear of the front location (100) so as to provide both lighting of the left, right posters and the replacement poster. The display system has reduced thickness and consists of light materials. The case (1), the profiles and the frame (20) consist of aluminium for example. The removable device (2) also consists of light components and materials.

An electrical and mechanical interface is provided on the removable device (2) in order to establish, in a detachable manner, both a connection to an electrical power supply (11) located in the case (1) and securing of the device (2) in the front location (100). A plug (21) for connection to the electrical power supply (11) is for example placed on the cover (23) or the lid of the rear part. Means (22) for connecting to a connection (12) of the case (1) to a network are also provided at the rear of the removable device (2) notably for allowing transmission and reception of digital type data, via at least one two-way channel. This may also be either a telecommunication network or a local computer network. As illustrated in FIG. 2, the management and control electronic components are fixed at the rear of the flat screen (200), as for example a graphic card (28) for the flat viewing screen (200). The rear part of the removable device (2), closed by the cover (23), has a format with dimensions less than or equal to the format of the frame (20) of the front part. Attachment means (not shown) allow the management and control electronic components to be directly secured at the rear of the screen (200). These components, distributed over the back of the viewing screen of the front part, are positioned in a flattened space delimited by the protective cover (23), the thickness of which is between 2 and 10 cm. The different electronic components are distributed in an exploded way and are positioned flat at the back of the screen (200) in order to reduce the thickness of the removable device (2).

A central microprocessor unit (26) forming a high performance PC-compatible system (for example with a processor of the Pentium® 4 type) is thus integrated at the rear of the flat screen (200) under the cover (23) notably for supporting multimedia functions on this screen (200). The central processing unit (26) allows the execution of software modules for providing e.g. the management of images, a programming schedule, remote maintenance, marketing data processing, etc. In one embodiment of the invention, the central unit (26) controls and manages a sound control circuit of a sound card, a telecommunications control circuit, an input control circuit, a mass storage control circuit, a video control module (25) of the viewing screen (200). For reproducing sound information, the removable device (2) includes loudspeakers (201) receiving the signal of a tuner-amplifier connected to an electronic circuit of the music synthesizer type provided for supporting a large number of input sources while providing an output having CD type quality. Any other means using a DSP type digital sound device (Digital Signal Processor) may also be used. The loudspeakers (201) are for example positioned on the front face of the frame (20) in which the viewing screen (200) is mounted.

Storage means (27) using at least one hard disk of the high speed and high capacity type are for example associated with the storage means already present in the central unit (26). The storage means (27) may also comprise one or more flash memories or any known type of fast access memory. These storage means (27) are used for storing digitized and compressed information, representative of audio-video/digital images and animations. It is thereby possible to keep a library of synthesis images, animations and video information, the processing unit allowing this library to be managed. The digitally controlled display device (2) also comprises a telecommunications modem for example of the ISDN (Integrated Services Digital Network), STN (Switch Telephone Network) or using for example DSL or ADSL (Asymmetric Digital Subscriber Line) technology or of the type associated with a radiotelephone network or any other telecommunications hardware associated with other integrated telecommunications media for allowing connection with an audiovisual information distribution network controlled by a central server. The removable digitally controlled display device (2) may therefore be remotely controlled by a programming server connected to the telecommunications network and having sources of information to be remotely transmitted, these information sources notably including video and animation data. Said programming server provides control of a remote maintenance piece of equipment of said device (2). Thus, the state of the display device and the course of the programs to be broadcasted may be controlled. Changes are allowed, for example automatically upon a particular event or also if a malfunction is detected.

In an embodiment of the invention, a ventilated heat-controlled 240 Watt power supply or another power supply of a known type supplies power to the system. This power supply is for example protected against overintensities and overoscillations. The cover (23) may comprise portions (24) with a suitable shape with relief or recesses which may correspond to the location of the fluorescent sources of the lighting system (4). It is understood that the front location (100) or the housing of the case (1) has a determined volume in order to contain the rear part of the removable device (2), for example equal to the volume occupied by the removable device (2) and is configured in order to maximally reduce the thickness of the display system according to the invention. The electronic components at the rear of the screen (200), confined under the cover (23), are cooled by a natural or forced ventilation system. As illustrated in FIG. 2, at least one air exhauster (51) may be provided near a ventilation outlet duct. One or more ventilation intake ducts (50) bring air into the rear part of the removable digitally controlled display device (2). These means for removing air heated by the electronic components and display components are for example positioned on the sides of the rear part protected by the cover (23). The ventilation system may be completed with a localized cooling system to evacuate heat given off by one of the handling and control electronic components. The cooling system may include one or more Peltier effect cells (53), notably used for cooling the microprocessor of the processing unit (26). Any other component (25, 27, 28) may also be cooled in this way. In FIG. 2, air flow channelling partitions (52) are illustrated in the rear part of the device (2) to delimit at least one limited area of forced ventilation around the electronic component. A heat-conducting heat exchanger system may also be used for cooling the processing unit (26) or other components (25, 27, 28).

In the example of FIG. 2, the removable digitally controlled display device (2) comprises a reader (29) of digital data media disks. An operator may thereby handle the display system by choosing a medium such as a DVD (Digital Versatile Disc) disc which may be read by the reader in order to broadcast digital type information on the screen (200).

The viewing screen (200) of the removable device (2) has determined dimensions substantially equal to the dimensions of the frontal opening (10). Matching means are provided in the video control module (25) of the screen (200) in order to match digital data representative of video and/or animations to the format of the viewing screen (200). A video 4/3, 16/9 or another video format may therefore be used without there being deformation effects occurring on the screen.

The invention will now be described in connection with FIGS. 3 and 4.

In the embodiment of FIG. 3, the digitally controlled display device (2) is fitted with an interface input circuit also with a remote control assembly (6) for example consisting of
an infrared transmitter remote control (6) notably for controlling the processing unit (26),
an infrared receiver (60) with adapter.

A radiofrequency system, an electronic chip control of the Bluetooth® type, an internal network, a keyboard system or another physically connected system may also be contemplated. With the remote control (6), an operator, for example a restaurant or bar manager, may access programming software stored in the storage means (26) and control different commands such as the mute command for the loud-speakers (201), the sound volume control command, the on/off command, the command for controlling the video disc reader (29), the programming command to display a selection menu and to select a file in a library of the storage means (27) or digital data available on a server of the network to which the display system is connected, etc. The removable digitally controlled display device (2) may comprise other types of interfaces with the user connected through a physical connection to the processing unit so as to provide control of the display on the screen, by using programming software stored in the storage means (26).

Each ventilation intake (500) may advantageously be provided with a filter or a grid, notably for retaining dust. In one alternative, the ventilation intake (500) comprises a grid or a filtering system for retaining oil vapours, fats, and other particles (smoke particles, etc.). A metal grid may also be provided in front of the inlet and/or outlet openings (500, 510), the mesh dimension of this grid being determined so as to suppress or limit emission of waves. In an alternative embodiment, metal wool or a similar structure, including active coal particles, is positioned in the openings so as to suppress or limit emission of waves on the one hand, and to fix and oxidize oil particles on the other hand. As illustrated in FIGS. 3 and 4, the forced ventilation outlets (510) may be positioned in the upper part, for example the upper angles of the front face, of the digitally controlled display device (2).

FIG. 4 illustrates an embodiment of the invention wherein the removable device (2) is inserted in a back-lighted case (1′) comprising two frontal openings (10). The fluorescent tubes of the lighting system (4) are positioned behind the digitally controlled display device (2) and allow a poster (3) to be lit up, shown here below the flat screen (200) of the digital video screen. The respective positions of the screen and of the poster of course are interchangeable. The removable device (2) is actually dimensioned so as to be interchangeable with a poster frame (3) shown through said frontal opening (10), the means (16) for supporting the poster frame (3) being configured so as to be attached to fast securing means of the removable device (2). The lighting system (4) for example comprises at least one fluorescent tube positioned parallel to the frontal openings. The case (1′) of FIG. 4 thus comprises several vertical tubes, 3 to 6 tubes for example, substantially extending over the whole height of the case (1′). As an alternative, the fluorescent tubes may be tilted. The cover (23) of the device (2) has protection properties against optical and electromagnetic radiations so as to prevent heating and wear of the electronic components. In one embodiment of the invention, the protection cover (23) includes a metal material with reflecting properties. For example the cover is made in metal and with it, emission of electromagnetic waves outwards from the electronic components may be suppressed or limited.

It is understood that the device system allows a dynamic screen (200) to be positioned on the side, above, below, or in the middle of one or more static posters, illuminated by the lighting system (4) of the case (1′). In the embodiment of FIG. 4, the case (1′) comprises an opening frame (13) with transparent window(s) which is hinged so as to fold it back against the frontal openings (10). Alternatively, the opening frame (13) may simply have the capability of being dismantled and possibly broken down into several parts corresponding to the frontal openings (10).

The invention will now be described in connection with FIGS. 1, 5a and 5b.

In the embodiment of FIGS. 5a and 5b, the case (1″) is substantially trapezium-shaped. It comprises a horizontal bottom and top, the bottom of the case being substantially vertical. It has a frontal opening (10) for the removable digitally controlled display device (2), tilted with an angle between 0 and 30°. The maximum thickness of the case (1″) remains less than 30 cm. The lighting system (4) is formed with lighting sources such as fluorescent neon tubes, distributed over the height of the case (1″). The lighting system (4) may be supported by a stiffening device (14) secured to the case (1″) by attachment means (15). A power supply (61) for fluorescent tubes is integrated at the rear of the case (1″).

The frontal opening (10) may be turned downwards, the case (1″) being intended to be suspended in height and/or secured against a wall. The display system comprises a minimum amount of connections and forms a smoke channelling screen (a smoke shield screen and resistant to fire for 15-30 minutes). The front face of the removable device may lack electrical connection plugs. FIG. 5a shows the display system with presentation of a static poster (3) inserted in supporting means (16). These supporting means may consist of profiles placed at the rim of the frontal opening so as to maintain and show the poster (3) through the frontal opening (10). In one embodiment of the invention, the case (1″) includes horizontal profiles positioned below and above the opening (10) capable of being fastened with complementary profiles placed on the removable device (2). The poster frame may also be provided with such complementary profiles so as to be secured in the same way as the removable device. Thus, the profiles of the frontal opening (10) are capable of being fastened onto complementary profiles located at the periphery of the poster frames (3) and of the removable device (2), respectively. Other attachment systems of a known type on the removable device (2) may of course be contemplated, so as to form a mechanical interface capable of fixedly and removably holding the device (2) in location (100). FIG. 5b shows the display system with the removable digitally controlled display device (2) built into the case (1″). The removable device (2) is held and powered with current via the electrical and mechanical interface. In the embodiment of FIGS. 5a and 5b, the arrangement of the profiles forming both the means for supporting the poster frames (3) and the removable device (2) is investigated in order to provide an optimized distribution of the weight in the case (1″). The device system may thus be suspended for example from rails (17) attached to a ceiling. The system according to the invention therefore has a homogeneously distributed load, unlike most of the known display devices. The reader (29) of video digital data media disks comprises an access door located outside the location (100) where the rear part of the removable device (2) will fit in. FIGS. 5a and 5b may correspond to sectional views of a display system with several openings (10) such as the one shown in FIG. 1. The framing of the openings (10) may be achieved with profiles, the shape of which depends on the format of the case (1″), for example. These profiles form one or more opening frames (13) provided with fast fastening systems so as to be disassembled easily. Such profiles are also opaque and mounted so as to completely block the light rays from the inside of the case (1″).

The cover (23) is positioned at a small distance from the lighting system (4) so as not to increase the thickness of the case (1″). The display system according to the invention may therefore have all the features of a conventional back-lighted case of the menu board type so as to show static posters (3), as illustrated in FIG. 5a, while providing integration of a digitally controlled display device (2) by simple connection in the connection plugs of a location (100) or housing of the case (1″). The design of the system allows components to coexist in a confined medium subject to thermal and radiative stresses, while homogeneously distributing the load of these components in the case (1).

With reference to FIG. 5c, the case (1′″) may have a parallelepipedous shape, for example a rectangular shape. The front face is then parallel to the bottom of the case (1′″).

In the embodiment of FIGS. 6a and 6b, the case may be sealed and therefore lack ventilation openings. Cooling by a radiator effect and recycling of inside air provides homogenization of the inside temperature of the removable device (2), the latter temperature remaining at a not very high value, for example at a temperature less than 40° C. The rear surface (202) or the totality of the cover (23) of the removable display device (2), for example based on aluminium (cast alumina) or another suitable metal, provides transmission of heat by radiation and by convection. As illustrated in FIG. 6b, a radial ventilation assembly (520) is provided in the rear part of the removable display device (2) in order to optimize the heat transmission through the cover (23). In other words, the cover (23) plays the role of a heat exchanger with the outside world. By using at least two fans to produce radial ventilation in the removable display device (2), it is possible to provide air flow in a rotary direction (A), as illustrated in FIG. 6a. In the embodiment of FIG. 6a, embossing is achieved for the cover (23) so as to obtain constant mechanical strength while reducing the thickness by increasing the sectional inertia of the cover (23). Heat exchanges with the outside world are thereby enhanced since, because of the reduction in thickness, the heat resistance of the cover (23) is smaller, and the heat exchange surface with the inside air to be cooled is increased.

The invention will now be described in connection with FIGS. 7, 8, 8a and 8b, 9a and 9b.

In alternative embodiments, a device for stirring inside air is provided with at least one fan (521) tangentially positioned in order to lower the inside temperature in the removable display device (2), in particular in an area where the cooling air flows pass the electronic components with a high heat dissipation rate (203). As illustrated in FIG. 7 for a large size (for example 40 inches) screen, the flow of horizontal tangential air represented by the dotted arrow also passes along the electronic components with a lesser heat dissipation rate (204). Extraction of heated air is performed from the rear of the removable display device (2).

With reference to FIGS. 7, 8a and 8b, the flow of air may be upwards, with at least one intake (522) at the front of the device (2) below the flat screen and a discharge outlet (523) at the rear of the device (2). At least one fan (521) positioned tangentially is provided near the discharge outlet (522) for extracting the heated air. In the embodiment of FIGS. 9a and 9b, cooling may be carried out by natural convection. The device (2) is of a suitable format depending on the location (100) of the case, left free by the poster. Thus, the frame (20) may be substantially square with a 20 inches (50 cm) screen as illustrated in FIG. 9a.

The removable digitally controlled display device (2) may fit into existing boxes or cases, attachment means being provided in order to allow it to be built into a box by either using the support means (16) of the poster frame of the box or not. Complementary securing means for example including rails or guiding ribs may allow the device (2) to be secured. First and second horizontal rails mounted in the case for example allow the upper side and underside of the device (2) to be secured, respectively. Removal of the device (2) may be performed in two phases, first with disengagement of the top of the device (2) relatively to the first rail and then disengagement of the bottom of the device (2) relatively to the second rail.

One of the advantages of the device system according to the invention is the modularity and the flexibility of the dynamic display, the digital video screen having the shape of a removable device (2) which may easily be added or removed. The dynamic display system is further well suited for use in cafés and large food service chains, the ventilation openings either being suppressed or provided with a filter or a specific grid to prevent clogging up of the inside parts and limiting emission of electromagnetic waves.

It should be obvious for the skilled practitioners that the present invention allows embodiments in many other specific forms without departing from the scope of application of the invention as claimed.

1. A dynamic display system that includes a case provided with at least one front opening and at least one support means in the case for supporting at least one removable poster frame, a distributed lighting system in the case to provide backlighting for-said posters, characterized in that at least one removable, digitally controlled, display device is fitted instead of at least one poster frame so as to cover said front opening(s), wherein said removable device includes front part, formed from a frame and a flat viewing screen mounted in the frame, and a control and management rear part attached to the back of the front part, an electrical and mechanical interface being provided on the removable device in order to establish, in a detachable manner, both a connection to an electrical power supply located in the case and securing of the device in a front location of the case.

2. A dynamic display system according to claim 1, wherein said viewing screen is mounted in a frame whose shape and dimensions correspond to an associated poster frame, with securing means, attached to the frame, being provided to hold the viewing screen in a frontal position.

3. A dynamic display system according to claim 1, in which the removable device is dimensioned to be interchangeable with a poster frame presented through the said front opening, with the support means of the poster frame being arranged to be attached to fast securing resources on the removable device.

4. A dynamic display system according to claim 1, in which the lighting system includes at least one fluorescent tube, with the rear part of the removable digitally-controlled display device including a protective cover against optical and electromagnetic radiations.

5. A dynamic display system according to claim 1, in which the rear part of the removable device has dimensions that are less than or equal to those of the frame of the front part, with the rear part including electronic management and control components secured by attachment means and distributed over the back of the viewing screen constituting the front part, with all of said electronic components being placed in a flattened volume of suitable shape, delimited by a protective cover whose thickness is between 2 and 10 cm.

6. A dynamic display system according to claims 1, in which the rear part of the screen includes, in particular:
a module for video control of the flat screen,
graphics card means with or without a sound card,
a processing unit for the execution of software modules and in particular the management of multimedia functions on the flat screen,
storage means for storing data representing images and audiovisual/numerical displays.

7. A dynamic display system according to claim 1, in which the removable device includes means for communication and connection to a network, to send and to receive notably, data of the digital audiovisual type, via at least one two-way channel.

8. A dynamic display system according to claim 5, in which the removable digitally-controlled display device includes means for removing air heated by the electronic management and control components and the display components.

9. A dynamic display system according to claim 5, in which the rear part includes at least one localized cooling system for removing the heat given off by at least one of the electronic management and control components.

10. A dynamic display system according to claim 8, in which the removable display device includes a ventilation intake equipped with a filtration system to retain oil vapours, greasy substances and other particles (smoke, etc.).

11. A dynamic display system according to claim 4, in which the frontal housing of the case has a volume that is determined to contain the rear part of the removable device, the protective cover including a metallic material with reflective properties, and said case including an opening frame with a window that is removable or hinged so that it can be folded back against the front opening.

12. A dynamic display system according to claim 1, in which the removable device includes a reader for digital data media disks.

13. A dynamic display system according to claim 12, in which the reader is arranged to be reached directly via an access door located on the outside of the frontal location.

14. A dynamic display system according to claim 6, in which the viewing screen of the removable device has dimensions which are designed to be more or less equal to the dimensions of the front opening, with matching means being provided in the screen video-control module in order to match the digital data representing the video and/or animation to the format of the viewing screen.

15. A dynamic display system according to claims 1, in which the support means for the poster frames consist in retaining profiles placed around the periphery of the front opening and suitable for attaching to complementary profiles located on the periphery of the poster frames and of the removable device, respectively.

16. A dynamic display system according to claim 6, in which the removable digitally-controlled display device includes user interface means connected through a physical and/or remote connection to the processing unit so as to provide control of the display on the screen, by using programming software stored in the storage means.

17. A dynamic display system according to claim 7, in which the removable digitally-controlled display device is remotely controlled by a programming server connected to the network, and having information sources to be remotely transmitted, these information sources including digital data said programming server controlling equipment for remote maintenance of the said device.

18. A dynamic display system according to claim 1, in which the case is substantially of trapezoidal shape, with the case including a horizontal top and bottom, the back of the case being substantially vertical, the front opening for the removable digitally-controlled display device being inclined at an angle of between 0 and 30 degrees, the maximum thickness of the case remaining under 30 cm and with a minimum thickness of the order of 10 cm, and the lighting system including lighting means distributed over the height of the case.

19. A dynamic display system according to claim 1, in which air-flow channelling partitions are provided in the rear part, in order to form at least one restricted zone of forced ventilation around electronic components.

20. A removable digitally-controlled display device that is intended to replace at least one poster frame in a box or case of the type with a back-lit display and provided with at least one support mean for supporting at least one removable poster frame and at least one front opening with frontal location of specified dimensions, the device being characterized in that it includes an electrical and mechanical interface in order to establish, in a detachable manner, both a connection to an electrical power supply located in the case and securing of the device in the frontal location, a front part, formed by a frame and a flat viewing screen mounted in the frame, and a control and management rear part attached to the back of the front part.

21. A removable display device according to claim 20, wherein said viewing screen is mounted in a frame whose shape and dimensions correspond to an associated poster frame, with securing means attached to the frame being provided to hold the viewing screen in a frontal position.

22. A removable display device according to claim 20, in which the rear part of the removable digitally-controlled display device includes a protective cover against optical and electromagnetic radiations.

23. A removable display device according to claim 20, in which the rear part of the removable device has dimensions that are less than or equal to those of the frame of the front part, with the rear part including electronic management and control components secured by attachment means and distributed over the back of the viewing screen constituting the front part, with all of said electronic components being placed in a flattened volume of suitable design, capped by a protective cover whose thickness is between 2 and 10 cm.

24. A removable display device according to claim 20, in which the rear part of the screen includes, in particular:
a video control module for the flat screen,
graphics card means and a sound card,
a processing unit for the execution of software modules and, in particular, the management of multimedia functions on the flat screen,
storage means for storing data representing images and audiovisual/digital animations.

25. A removable display device according to claim 20, including means for communication and connection to a network for transmission, and reception, of data of the digital audiovisual type, via at least one two-way channel.

26. A removable display device according to claim 20, including a ventilation intake equipped with a filtration system to retain oil vapours, greasy substances and other particles (smoke, etc.).

27. A removable display device according to claim 23, including means for removing the air heated by the electronic management and control components and the display components.

28. A removable display device according to claim 23, of the type without a ventilation opening and including a radial ventilation assembly provided for mixing the air heated by the electronic management and control components and for ensuring the transmission of heat through the protective cover, the said cover being metal-based and designed to transmit the heat by convection and radiation.

29. A removable display device according to claim 20, in which said rear part is equipped with at least one fan positioned tangentially so as to provide an upward air circulation, with at least one ventilation intake being provided at the front of the device below the viewing screen, and a discharge outlet at the rear of the device.

30. A removable display device according to claim 24, in which the viewing screen has dimensions that are designed to be more or less equal to the dimensions of the front opening, with matching means being provided in the video control module of the screen in order to match the digital data representing video and/or animations to the format of the display screen.

31. A removable display device according to claim 25, including remote maintenance equipment that can be remotely controlled by a programming server connected to the network and having information sources for remote transmission, these information sources including digital data.

32. A removable display device according to claim 25, in which the removable device includes a disk drive for digital media.

33. A dynamic display system according to claim 32, in which the disk drive is arranged to be reached directly via an access door located on the outside of the frontal location.
